(19) United States
(12) Patent Application Publication
(10) Pub. No.: US 2011/0051718 A1
(43) Pub. Date: Mar. 3, 2011

(54) METHODS AND APPARATUS FOR DELIVERING AUDIO CONTENT TO A CALLER PLACED ON HOLD

(75) Inventor: Michael A. Sharp, Porter, TX (US)

(73) Assignee: BAND TONES,LLC

(21) Appl. No.: 12/735,322

(22) PCT Filed: Jan. 2, 2009
(86) PCT No.: PCT/US2009/030024

§ 371 Date: Jul. 2, 2010

Related U.S. Application Data
(60) Provisional application No. 61/018,913, filed on Jan. 4, 2008.

(51) Int. Cl. H04L 12/66

(52) U.S. Cl. 370/352

(57) ABSTRACT

Several methods and systems for providing audio content to callers placed on hold are described. In some on-hold phonecasting methods, a two-way telecommunications link is established between a caller and a call terminus. The caller or the call terminus is temporarily isolated from the link. The audio content is provided via the link while the caller or call terminus is isolated to indicate that the link is still in place. At least a portion of the audio content is specified by a really simple syndication feed. The audio content may include one or more podcasts publicly available via the Internet. The audio content may be generated according to configuration information and by concatenating an audio advertisement or public service essage with the portion of the audio content. The method may also include periodically checking the RSS feed for updates to the audio content, and downloading updated audio content.

### CROSS-REFERENCE TO RELATED APPLICATIONS

The present application claims priority to Provisional U.S. Patent Application Ser. No. 61/018,913, filed Jan. 4, 2008 and entitled “METHODS AND APPARATUS FOR DELIVERING AUDIO CONTENT TO A CALLER PLACED ON HOLD” by inventor M. Sharp, hereby incorporated herein by reference in its entirety.

Commonly owned U.S. patent application Ser. No. 11/877,612, filed Oct. 23, 2007 and entitled “PHONECASTING SYSTEMS AND METHODS” by inventors M. Kaufman, M. Sharp, and C. Coleman, is hereby incorporated herein by reference in its entirety.

### BACKGROUND

With the development of Apple Inc.'s iPod®, portable players for digital media entered the mainstream. Such portable media players provide compact storage and playback of audio files (typically containing music), and more recent models include capabilities for storing and playing video files as well. The widespread availability of such devices created a platform for a new method of communication: podcasting. The term “podcast” is a combination of the words “iPod” and “broadcast.” The term “podcasting” generally refers to the ability to deliver subscription-based audio content via the Internet. In some embodiments, podcasting involves transmitting a copy of an audio file containing audio content from a server computer system to a client computer system via the Internet. The audio file may then be copied from the client computer system to a portable media player for subsequent playback.

Podcasting has achieved widespread success, and begins with a content provider publishing an audio file on the Internet. The content provider then references that audio file in a syndication file, which in addition to the uniform resource locator (URL) of the audio file, typically includes additional information such as title, description, publication date, etc., of the audio program along with similar information for any previous episodes of the program. The syndication file is commonly in a really simple syndication (RSS) format, though other standard formats are also suitable. For the most part, podcasts have only been accessible via computer.

When a person places a telephone (“phone”) call to a business or other enterprise to request information, to order a product, or to voice a complaint, it is often necessary to place the phone call on hold while gathering needed information. To fill the silence that would otherwise occur when a phone call is placed on hold, many businesses have adopted the practice of playing pre-recorded music to phone callers placed on hold, this practice being generally referred to as “music on hold.” Playing pre-recorded music to phone callers placed on hold has several positive effects, including reassuring callers that their calls are still connected, and entertaining callers while they are on hold. Playing pre-recorded music to phone callers placed on hold also has several drawbacks. Some callers may regard music on hold as cliché, and playing pre-recorded music to such callers while on hold may detract from the reputation of businesses wishing to have a cutting-edge high-tech image. Moreover, repeat callers may well hear the same music each time they are on placed on hold, and may no longer be entertained by the music.

### SUMMARY

The problems identified above are at least partly addressed by herein described methods and apparatus for delivering audio content. In some on-hold phonecasting methods, a two-way telecommunications link is established between a caller and a call terminus. The caller or the call terminus is temporarily isolated from the link. The audio content is provided via the link while the caller or call terminus is isolated to indicate that the link is still in place. At least a portion of the audio content is specified by a really simple syndication (RSS) feed. The audio content may include, for example, one or more podcasts publicly available via the Internet. The audio content may be generated by concatenating an audio advertisement or public service message with the portion of the audio content.

For example, the caller may be located at a caller location, and a called party may be located at the call terminus The caller may place a telephone call to the call terminus, establishing the two-way telecommunications link between the caller and the call terminus (and between the caller and the called party). During the telephone call, the called party may place the call on hold, temporarily isolating the call terminus from the link. While the call terminus is isolated from the link, a telephone system located at the call terminus may provide the audio content to the caller via the link to indicate that the link is still in place. Alternatively, during the telephone call, the caller may place the call on hold, temporarily isolating the caller from the link. While the caller is isolated from the link, a telephone system at the caller location may provide the audio content to the called party (at the call terminus) via the link to indicate that the link is still in place.

The generating of the audio content may be performed based on parameters of configuration information, where the parameters include a URL for the RSS feed. The parameters may also include an identifier for the audio advertisement or public service message, and an identifier of an on-hold audio content subscriber.

The method may also include periodically checking the RSS feed for updates to the audio content, and downloading updated audio content. The updated audio content may be reformatted to a companded format suitable for telephone or voice over Internet protocol (VoIP) communications links. The providing may include conferencing the link together with a voice over Internet protocol (VoIP) call to a server system.

In some embodiments, a telephone system includes a memory that stores PBX software and at least one processor coupled to the memory to execute the PBX software. The PBX software configures the processor to: establish a two-way telecommunications link between a caller and a call terminus, isolate the caller or the call terminus from the link, and provide audio content via the link until two-way communication is re-established.

At least a portion of the audio content is from a syndicated program. The syndicated program may be, for example, a podcast. As part of providing the audio content, the PBX software may configure the processor to connect the link to a server system via a VoIP call. The telephone system may generates the audio content by combining an audio message with the syndicated program. The message may be, for example, an advertisement or public service message.

The telephone system may select the audio message based on caller or calling number identification information. As a part of providing the audio content, the PBX software may configure the processor to periodically check for updates to the syndicated program and to download updated audio content when an update is detected. The PBX software may configure the processor to convert the updated audio content into a constant bit rate format.

### BRIEF DESCRIPTION OF THE DRAWINGS

A better understanding of the various disclosed embodiments can be obtained when the detailed description is considered in conjunction with the following drawings, in which:

FIG. 1 is a diagram of a system including an illustrative phonecasting system;

FIG. 2 is a diagram of one embodiment of a network server;

FIG. 3 is a diagram of a system including a server system and a telephone system coupled to a communication network, illustrating events that occur in the system when a user or administrator of the telephone system subscribes to audio content;

FIG. 4 is a diagram of the system of FIG. 3 illustrating transmission or downloading of an audio file containing the audio content from the server system to the telephone system via the communication network;

FIG. 5 is a diagram of the system of FIGS. 3-4 illustrating events that occur within the system when a telephone call placed to the telephone system is placed on hold;

FIG. 6 is a diagram of the system of FIGS. 3-5 where the audio file is transmitted or downloaded from the server system to the telephone system via a streaming process such that rendering or playing of the audio file begins before the entire audio file is received by the telephone system;

FIG. 7 is a flowchart of one embodiment of a method for delivering audio content to a telephone caller placed on hold;

FIG. 8 is a diagram of the system of FIG. 3 illustrating events that occur in the system when a user or administrator of the telephone system subscribes to audio content, and a telephone call placed to the telephone system by a caller is subsequently placed on hold; and

FIG. 9 is a flowchart of one embodiment of a method for delivering audio content to a telephone caller placed on hold.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### TERMINOLOGY

The term “feed” as used herein refers to a program, presentation, or other content made available for transmission or conveyance via the Internet. A feed can exist in various forms, including a podcast, a song or other fixed sound file, a periodically updated sound file, and a live media stream.

The term “phonecast,” when used herein as a noun, refers to a feed that can be accessed with a phone over the public switched telephone network (PSTN) and/or over a voice over internet protocol (VoIP) channel. When used herein as a verb, the term “phonecast” or “phonecasting” refers to the transmission or conveyance of a feed over a VoIP or PSTN channel to a phone.

The term “includes” as used herein is an open-ended term, as in “including, but not limited to”.

### DETAILED DESCRIPTION

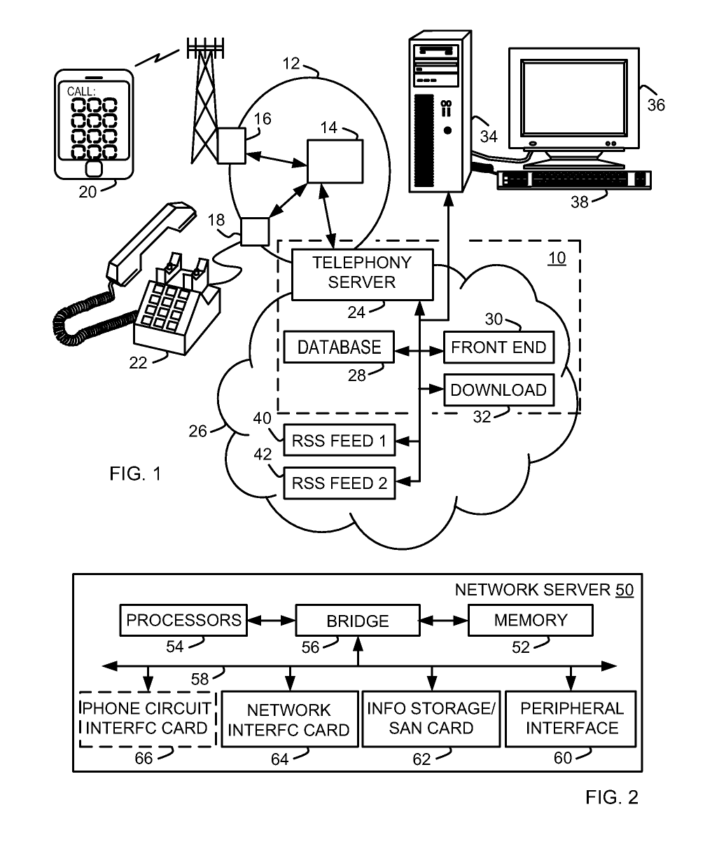

FIG. 1 is a diagram of a system including an illustrative phonecasting system 10 that can be adapted for use in providing a novel podcasting-on-hold service with significant commercial potential. The illustrative phonecasting system 10 includes a telephony server 24, a database server 28, a front end server 30, and a download server 32. The telephony server 24 couples to the public switched telephone network (PSTN) 12 to initiate and receive phone calls. In FIG. 1, the PSTN 12 includes a hierarchy of switches 14, 16, 18, and communication links that interconnect customer provided equipment (CPE) such as cellular (“cell”) phones 20, “land-line” phones 22, and modems. Often, though not necessarily, the telephony server 24 connects to the PSTN 12 via a trunk line that supports multiple simultaneous calls.

The telephony server 24 also couples to the Internet 26 to optionally send and receive streams of audio data. Alternatively, sound files can be played and recorded internally by telephony server 24. The telephony server 24 may include one or more servers running Asterisk® telephony engine software (Digium®, Inc., Huntsville, Ala.), the setup and operation of which is described in detail in J. Van Meggelen, J. Smith, and L. Madsen, Asterisk: The Future of Telephony, © 2005 O'Reilly Media, Inc., Farnham.

The telephony server 24 relies on the database server 28 to determine the audio program and introductory message that corresponds to the dialed phone numbers of incoming calls. With the links provided by the database server 28, the telephony server 24 initiates streaming of the appropriate files from the download server 32. The front end server 30 provides a Web site that serves as an interface for the phonecasting system 10 for Internet users. Internet users typically will run World Wide Web (“Web”) browser software on computers such as computer 34. The Web browser software displays a Web page on their monitor 36, with one or more fields for the user to populate via an input device 38.

Among other things, Internet users are able to enter Internet feed identifiers for, e.g., RSS (really simple syndication) feeds 40 and 42. The front end server 30 accesses the database server 28 to determine whether phone numbers have previously been assigned, and if not, the front end server retrieves an available phone number from the database and assigns it to the feed. If the phone number is newly assigned, the front end server 30 also notifies the download server 32 to initiate retrieval and translation of the feed. Once a phone number has been assigned, the front end server 30 generates a Web page for display on the user's computer monitor 36, showing the assigned phone number.

Though the illustrative phonecasting system 10 of FIG. 1 is shown as including four servers having separate functions, these functions can be consolidated and/or distributed as needed to provide the appropriate server capacity. FIG. 2 is a diagram of one embodiment of a network server 50, where the network server 50 may be, for example, the telephony server 24, the database server 28, the front end server 30, and/or the download server 32 of the phonecasting system 10 of FIG. 1. In the embodiment of FIG. 2, the network server 50 includes a memory 52, one or more processors 54, and a high-speed bridge 56 that connects the processor(s) 54 with the memory 52, and an expansion bus 58. The expansion bus 58 supports communication with a peripheral interface 60, an information storage device 62, an network interface card 64, and an optional peripheral interface 60 (e.g., a phone circuit interface card).

The peripheral interface 60 provides ports for communicating with external devices such as keyboards, mice, universal serial bus (USB) devices, printers, cameras, speakers, etc. On many servers, these ports may be left largely unused, but they are available for configuration, diagnostic, and/or performance monitoring purposes. The information storage device 62 is typically a nonvolatile memory for firmware and/or a hard drive for extended storage of software and data. On distributed systems with high data availability requirements, the information storage device 62 is replaced or supplemented with a storage area network (SAN) card that enables shared access to a large disk array. The network interface card 64 provides access to other network servers and usually to the Internet as a whole.

Referring to FIGS. 1 and 2, the telephony server 24 optionally includes an interface card 66 for connecting to the telephone circuits. In some alternative embodiments, the connection to the PSTN is accomplished indirectly via Voice over Internet Protocol (VoIP) techniques, eliminating the need for dedicated telephone circuit interface hardware.

Before the illustrative network server 50 boots, the relevant phonecasting software components are stored on the storage device 62, or sometimes on a network disk accessible via the network interface card 64. After the initial boot-up diagnostics are completed, the processor(s) loads the phonecasting software components into memory, either all at once or on an “as needed” basis (e.g., by paging the needed instructions into memory). As the processor(s) execute the software instructions, the software configures the operation of the illustrative server(s) in accordance with the methods and principles set forth herein.

More information about phonecasting systems and methods is available in U.S. patent application Ser. No. 11/877,612, filed Oct. 23, 2007 and entitled “PHONECASTING SYSTEMS AND METHODS” by inventors M. Kaufman, M. Sharp, and C. Coleman, which is hereby incorporated herein by reference in its entirety.

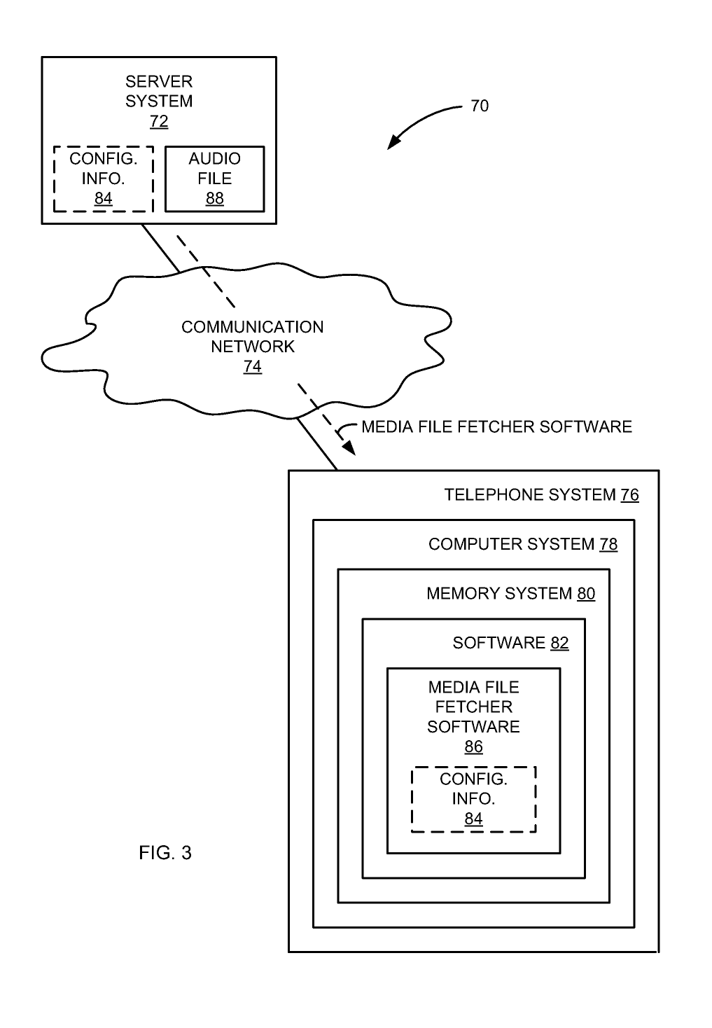

FIGS. 3-6 will now be used to illustrate one embodiment of an apparatus and method for delivering audio content to a telephone caller placed on hold. In some embodiments, at least a portion of the audio content is specified by a really simple syndication (RSS) feed. The audio content may be, for example, subscription audio content including at least one audio podcast and at least one audio advertisement or public service message. One or more of the podcasts may be publicly available via the Internet and specified by an RSS feed (e.g., the RSS feed 40 or 42 of FIG. 1). In some embodiments, an audio file is received by the telephone system and saved in the computer system. The content of the audio file is rendered (i.e., the audio file is played), thereby creating an audio signal conveying the audio content. The audio signal is provided to a telephone caller placed on hold.

FIG. 3 is a diagram of a system 70 including a server system 72 and a telephone system 76 coupled to a communication network 74, illustrating events that occur in the system 70 when a user or administrator of the telephone system 76 subscribes to the audio content. In the embodiment of FIG. 3, the communication network 74 includes the Internet (e.g., the Internet 26 of FIG. 1), and may also include the public switched telephone network (e.g., the PSTN 12 of FIG. 1). In FIG. 3, the server system 72 may include the telephony server 24, the database server 28, the front end server 30, and/or the download server 32 of the illustrative phonecasting system 10 of FIG. 1.

The telephone system 76 performs telephone switching functions (e.g., for a business or office building). The telephone system 76 may be configured like the network server 50 of FIG. 2. In some embodiments, the telephone system 76 is configured to switch incoming telephone calls between a number of local users, and to allow the users to make outgoing telephone calls. The telephone system 76 may be, for example, a private branch exchange (PBX). As indicated in FIG. 3, the telephone system 76 includes a computer system 78. Software 82 stored in a memory system 80 of the computer system 78 controls the functions of the telephone system 76. The software 82 preferably is, or includes, telephony engine or PBX software such as, for example, the Asterisk® telephony engine software (Digium®, Inc., Huntsville, Ala.).

When the user or administrator of the telephone system 76 subscribes to the audio content, the user or administrator generates configuration information 84. The configuration information 84 preferably includes a list of one or more audio podcasts to be included in the audio content. The configuration information 84 may also include a list of one or more audio advertisements and/or public service messages to be included on the audio content. In some embodiments, one or more of the podcasts to be included on the audio content is publicly available via the Internet and specified by an RSS feed (e.g., the RSS feed 40 or 42 of FIG. 1), and the configuration information 84 includes a URL for the RSS feed.

In some embodiments, the configuration information 84 includes several parameters, including a URL for the RSS feed specifying the at least one audio podcast, an identifier that identifies the at least one audio advertisement or public service message, and/or an identifier that identifies the on-hold audio content subscriber (e.g., the user or administrator of the telephone system 76, or the organization owning the telephone system 76). In some embodiments, the identifier is a subscription account number.

For example, the server system 72 may be or include a World Wide Web (“Web”) server. Using a Web browser, the user or administrator of the telephone system 76 may submit a request for a subscription form to the server system 72 via the communication network 74. The server system 72 may respond to the request by providing the subscription form to the user or administrator via the communication network 74.

In filling out the subscription form, the user or administrator may provide, for example, a list of one or more audio podcasts to be included in the audio content, and may also provide a list of one or more audio advertisements or public service messages to be included on the audio content. The user or administrator may also provide a URL for each podcast specified by an RSS feed, an identifier that identifies each audio advertisement or public service message, and/or an identifier that identifies himself or herself, or his or her organization, for subscription purposes.

After the user or administrator of the telephone system 76 provides the configuration information 84, the server system 72 uses the configuration information 84 to generate an audio file 88, and generates media file fetcher software 86 including computer instructions for downloading the audio file 88. The audio file 88 includes audio content to be delivering to a telephone caller placed on hold. In some embodiments, the audio file 88 includes at least one audio podcast (e.g., from the list of one or more audio podcasts in the configuration file 84) and at least one audio advertisement or public service message (e.g., from the list of one or more audio advertisements or public service messages in the configuration file 84). In some embodiments, one or more of the podcasts included in the audio file 88 is publicly available via the Internet and specified by an RSS feed, and the configuration information 84 includes a URL for the RSS feed.

Each audio advertisement or public service message may be positioned before, during, or after one of the audio podcasts. The audio file 88 may include, for example, multiple audio podcasts and multiple audio advertisements and/or public service messages, where each audio advertisement or public service message is positioned before, during, or after one of the audio podcasts.

In generating the audio file 88, the server system 72 may obtain one or more audio files via the communication network 74. The audio files may be formatted according to any one of several standard audio file formats, including, for example, the Moving Pictures Experts Group (MPEG) Audio Layer 3 (MP3) file format, the waveform audio (WAV) format, and the Windows media audio (WMA) format. The server 72 may include the audio files in the audio file 88 in their original format, or may reformat the audio files to a format more suitable for telephone or voice over Internet protocol (VoIP) communications links. For example, the server system 72 may reformat an audio file by obtaining the audio content from the audio file (i.e., decoding the audio content), re-sampling the audio content to, for example, 8 kHz monaural, and/or compressing the audio content using, for example, a μ-law companding algorithm, thereby producing a reformatted audio file. The server system 72 may generate the reformatted audio file using constant bit rate (CBR) encoding. The server 72 may include the resulting reformatted audio file in the audio file 88.

As indicated in FIG. 3, when a user subscribes to the on-hold phonecasting service, the system server 72 writes the media file fetcher software 86 directly to the software 82 of the telephone system 76, and the media file fetcher software 86 becomes a part of the software 82. In other words, during the subscription process, the server system 72 transmits media file fetcher software 86 to the telephone system 76 via the communication network 74 as shown in FIG. 3. Stated a different way, the server system 72 installs the media file fetcher software 86 in the software 82 of the telephone system 76, and the media file fetcher software 86 becomes a part of the software 82 by virtue of the installation process.

For example, the server system 72 may enable the user or administrator of the telephone system 76 to log in, provide the configuration information 84 for the telephone system 76, agree to contract terms, and pay subscription fees. After the configuration information 84 and the subscription fees are paid, the server system 72 may write the media file fetcher software 86 directly to the software 82 of the telephone system 76.

As indicated in FIG. 3, the configuration information 84 may be stored within the server system 72 and/or within the media file fetcher software 86. The configuration information 84 preferably remains editable by the user or administrator of the telephone system 76 to allow the user or administrator to update the configuration information at will.

When executed by computer system 78 of the telephone system 76, the media file fetcher software 86 communicates with the server system 72 via the communication network 74, and initiates a download (or, in some embodiments, a streaming playback) of the audio file 88 from the server system 72 to the telephone system 76 via the communication network 74.

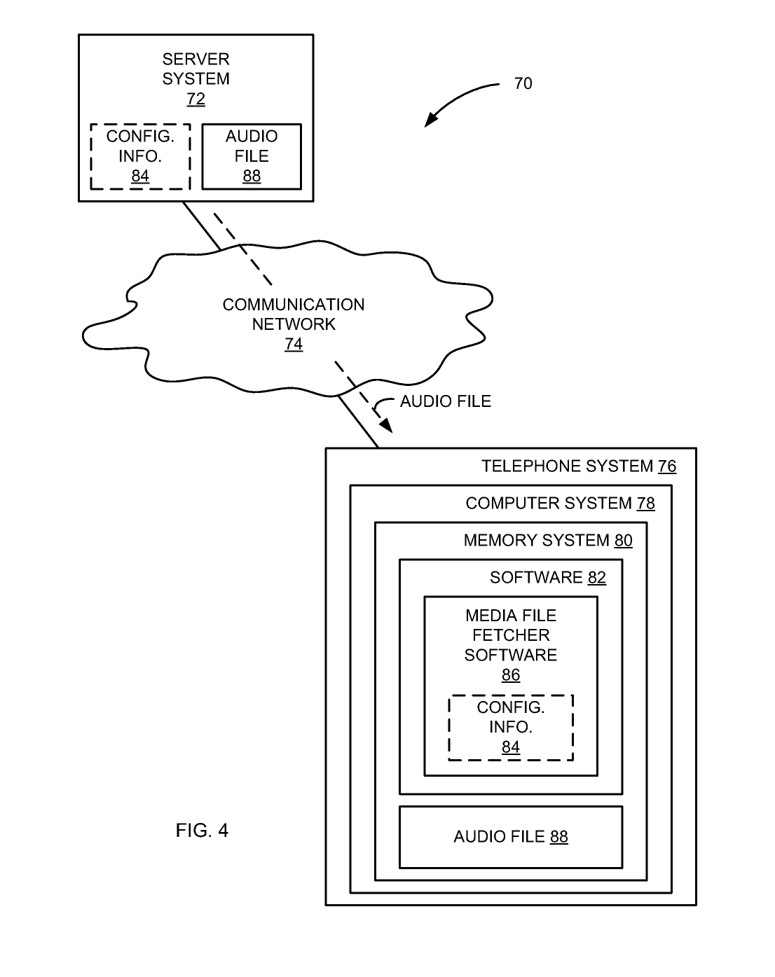

FIG. 4 is a diagram of the system 70 of FIG. 3 illustrating transmission or downloading of the audio file 88 containing the audio content from the server system 72 to the telephone system 76 via the communication network 74. The audio file 88 is received by the telephone system 76 and stored in the memory system 80 of the computer system 78 of the telephone system 76.

As described above, one or more of the podcasts included in the audio file 88 may be specified by an RSS feed (e.g., the RSS feed 40 or 42 of FIG. 1). The server system 72 may periodically check the RSS feed for updates to the one or more podcasts via the communication network 74. If any one of the one or more podcasts included in the audio file 88 has been updated, the server system 72 may initiate transmission of the updated podcast via the communication network 74. The server system 72 may then update the audio file 88 to include the updated podcast.

The updated podcast me be, for example, an MPEG MP3 audio file. In generating the updated audio file 88, the server system 72 may include the updated podcast in the audio file 88 in the MPEG MP3 format, or reformat the updated podcast to a format more suitable for playback over a telephone connection. For example, the server system 72 may reformat the updated podcast by obtaining the audio content from the MPEG MP3 file (i.e., decoding the MPEG MP3 file), re-sampling the audio content to, for example, 8 kHz monaural, and/or compressing the audio content using, for example, a μ-law companding algorithm, thereby producing a reformatted audio file. The server system 72 may generate the reformatted audio file using constant bit rate (CBR) encoding. The server 72 may include the resulting reformatted audio file in the updated audio file 88.

The media file fetcher software 86 may periodically communicate with the server system 72 via the communication network 74 to see if the audio file 88 has been updated. If the audio file 88 has been updated, the media file fetcher software 86 initiates transmission of the updated audio file 88 from the server system 72 to the telephone system 76 via the communication network 74.

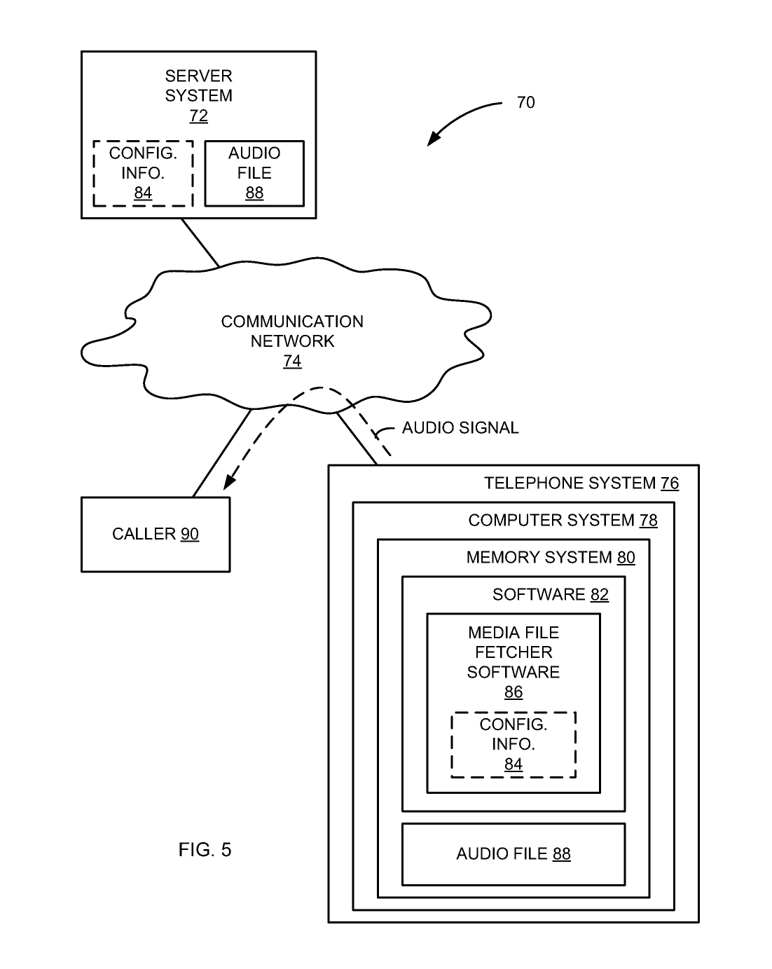

FIG. 5 is a diagram of the system 70 of FIGS. 3-4 illustrating events that occur within the system 70 when a telephone call placed to the telephone system 76 is placed on hold. In FIG. 5, a telephone caller 90 places an incoming call to the telephone system 76 via the communication network 74, and is placed on hold by a user of the telephone system 76. Within the telephone system 76, the audio file 88 is being rendered (e.g., played by a media player), thereby generating an audio signal that conveys the audio content contained in the audio file 88. When the caller 90 is placed on hold, the telephone system 76 provides the audio signal to the caller 90.

The telephone system 76 may include a switching network having multiple ports: several outside ports, several inside ports, and a hold port. Each of the outside ports may be connected to an outside telephone line (e.g., a pair of conductors connected to the PSTN). Each of the inside ports may be adapted for coupling to an inside telephone line (e.g., a pair of conductors forming a telephone line that extends within a building). The switching network may be configured to connect any one or more of the outside ports to any one or more of the inside ports, thereby, for example, routing an incoming call received via one of the outside telephone lines to a receiving party within the building, or allowing a calling party within the building to place a call via one of the outside telephone lines.

In addition, the switching network may be configured to connect any one of the outside ports to the hold port. For example, in response to input from a user of the telephone system 76 that an incoming call received via a corresponding one of the outside ports needs to be placed on hold, the switching network may form a connection between the corresponding outside port and the hold port. The hold port may be connected to receive an output of the media player that is rendering or playing the audio file 88. In this manner, the audio signal generated by the media player is provided to the caller 90 while the caller 90 is on hold.

In response to input from a user of the telephone system 76 that the incoming call on hold needs to be taken off of hold, the switching network may break the connection between the corresponding outside port and the hold port, and make a connection between the outside port and one of the inside ports. In this way, the caller 90 is taken off of hold and expectedly connected to a receiving party within the building.

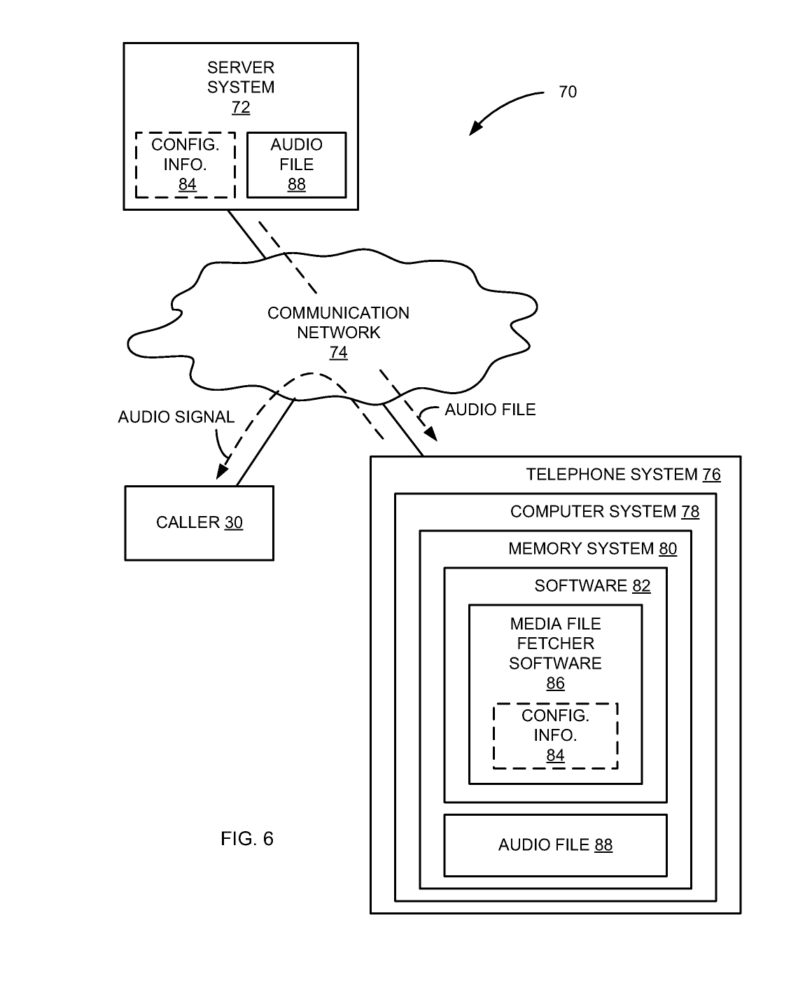

FIG. 6 is a diagram of the system 70 of FIGS. 3-5 where the audio file 88 is transmitted from the server system 72 to the telephone system 76 via a streaming process such that the rendering or playing of the audio file 88 begins before the entire audio file 88 is received by the telephone system 76. The embodiment of FIG. 6 is beneficial in that it is not necessary for the entire audio file 88 to be received by the telephone system 76 before the rendering or playing of the audio file 88 may begin.

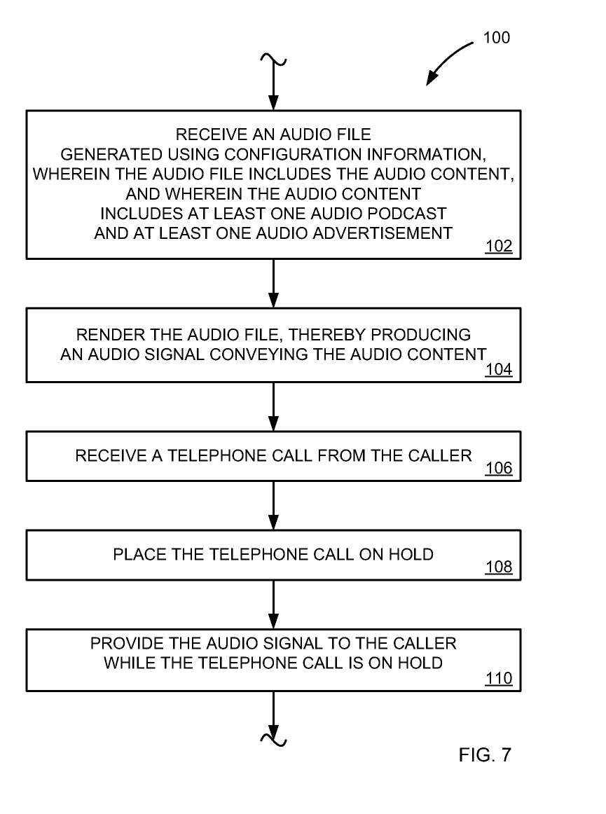

FIG. 7 is a flowchart of one embodiment of a method 100 for delivering audio content to a telephone caller placed on hold. During a step 102 of the method 100, an audio file is received (e.g., by the telephone system 76 of FIGS. 3-6), where the audio file was generated using configuration information (e.g., by the server system 72 of FIGS. 3-6). The audio file includes the audio content, where the audio includes at least one audio podcast, and may include at least one audio advertisement or public service message. The configuration information may include a list of audio podcasts, audio advertisements, and/or public service messages to be included in the audio content. In some embodiments, one or more of the podcasts included in the audio file is publicly available via the Internet and specified by an RSS feed, and the configuration information includes a URL for the RSS feed.

In some embodiments, the configuration information includes several parameters, including a URL for the RSS feed specifying at least one audio podcast, an identifier that identifies at least one audio advertisement or public service message, and/or an identifier that identifies the on-hold audio content subscriber (e.g., a user or administrator of a telephone system, or an organization that owns the telephone system).

Each audio podcast included in the audio content may be or include recorded verbal communication, or recorded music. The recorded verbal communication may be, for example, a speech, a conversation, or an interview. Each audio advertisement included in the audio content may be, for example, a recorded verbal communication promoting a specific product or brand name. Within the audio content, the audio podcasts and the audio advertisements are arranged in sequence. For example, the audio content may include multiple audio podcasts, multiple audio advertisements, and multiple public service messages, where each audio advertisement and public service message is either before, during, or after one of the audio podcasts.

As described above, the audio file is formatted for playback over a telephone connection. The audio file may be formatted according to the MPEG MP3 file format. Alternately, the audio file may be any one of several suitable standard audio file formats, such as the WAV format or the WMA format.

The audio file is rendered or played during a step 104 (e.g., by the telephone system 76 of FIGS. 3-6), thereby producing an audio signal conveying the audio content. Some systems may continuously play or “loop” the audio content irrespective of whether a caller is on hold. Other systems initiate playback whenever a caller is placed on hold. During a step 106, a telephone call is received from the caller (e.g., by the telephone system 76 of FIGS. 3-6). The telephone call is placed on hold during a step 108. During a step 110, the audio signal is provided to the caller while the telephone call is on hold.

For example, as described above, in response to input indicating that an incoming call received via an outside port of a switching network of a telephone system (e.g., the telephone system 76 of FIGS. 3-6) needs to be placed on hold, the switching network may form a connection between the corresponding outside port and a hold port. The hold port may be connected to receive an output of a media player that is rendering or playing the audio file. In this situation, an audio signal generated by the media player is provided to the caller while the caller is on hold.

In response to input indicating that the incoming call needs to be taken off of hold, the switching network may break the connection between the corresponding outside port and the hold port, and make a connection between the outside port and an inside port. In this way, the caller is taken off of hold and expectedly connected to a receiving party.

The method 100 of FIG. 7 is one embodiment of an on-hold phonecasting method. During the step 106, a two-way telecommunications link is established between the caller and a call terminus (e.g., a telephone handset connected to an inside port of the telephone system 76 of FIGS. 3-6). During the step 108, the telephone call is placed on hold, temporarily isolating the call terminus from the link. During the step 110, audio content is provided to the caller via the link while said call terminus is isolated from the link to indicate that the link is still in place. It is noted that at least a portion of the audio content is specified by a really simple syndication (RSS) feed as described above.

Referring back to FIGS. 3-6, the software 82 stored in the memory system 80 of the telephone system 76 of the system 70 may include PBX software. The computer system 78 of the telephone system 76 may include a processor coupled to the memory system 80 and configured to execute the software 82. When executed by the processor, the PBX software may configure the processor to establish a two-way telecommunications link between the caller and the call terminus, to isolate the caller or the call terminus from the link, and to provide audio content to the caller via the link until two-way communication is re-established.

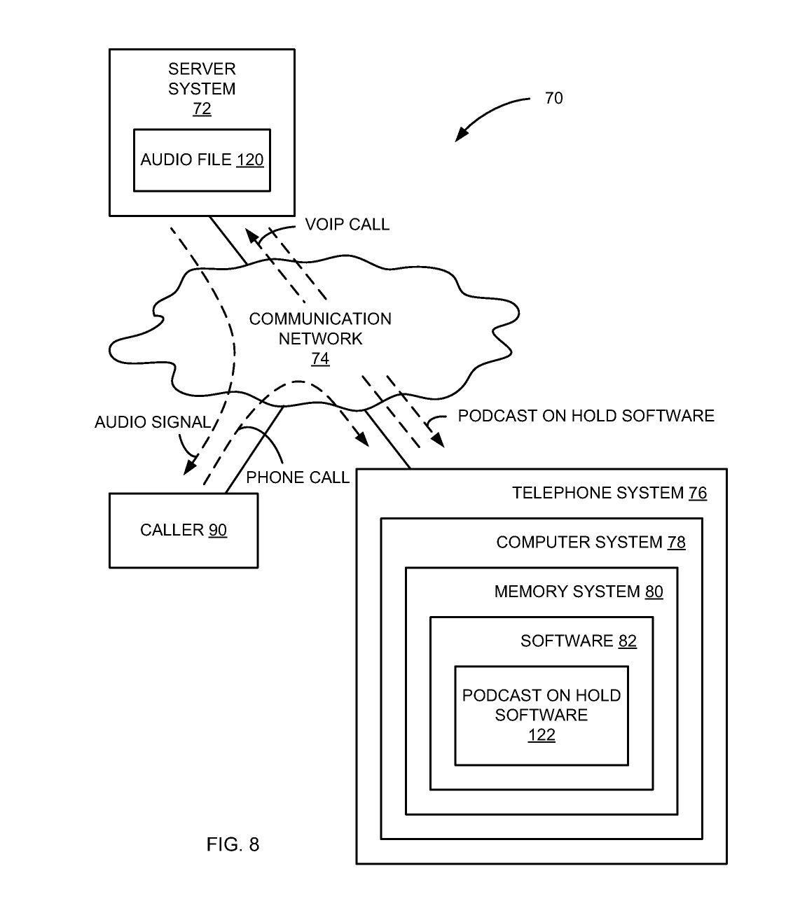

FIG. 8 will now be used to illustrate one embodiment of an apparatus and method for delivering audio content to a telephone caller placed on hold. FIG. 8 is a diagram of the system 70 of FIG. 3 illustrating events that occur in the system 70 when a user or administrator of the telephone system 76 subscribes to the audio content, and a telephone call placed to the telephone system 76 by a caller is subsequently placed on hold. During the subscription process, podcast on hold software 122 is transmitted from the server system 72 to the telephone system 76 via the communication network 74. In a preferred embodiment, the server system 72 writes the podcast on hold software 122 directly to the software 82 of the telephone system 76, and the podcast on hold software 122 becomes a “plug-in” available for execution by the software 82.

In the embodiment of FIG. 8, the server system 72 includes an audio file 120 containing the audio content, where the audio content includes at least one audio podcast, and may include at least one audio advertisement or public service message. The audio file 120 may be generated using configuration information provided by the user or administrator of the telephone system 76. The configuration information may include a list of audio podcasts and audio advertisements or public service messages to be included in the audio content. In some embodiments, one or more of the podcasts included in the audio file 120 is publicly available via the Internet and specified by an RSS feed, and the configuration information includes a URL for the RSS feed.

The audio file 120 may be formatted according to any one of several standard audio file formats, including, for example, the MPEG MP3 file format, the WAV format, and the WMA format. Alternately, the server system 72 may create the audio file 120 by obtaining audio content from one or more audio files (i.e., decoding the audio content), re-sampling the audio content to, for example, 8 kHz monaural, and/or compressing the audio content using, for example, a μ-law companding algorithm, thereby producing a reformatted audio file. The server system 72 may generate the reformatted audio file using constant bit rate (CBR) encoding. The server 72 may include the resulting reformatted audio file in the audio file 120.

In some embodiments, the configuration information used to generate the audio file 120 includes several parameters, including a URL for the RSS feed specifying at least one audio podcast, an identifier that identifies at least one audio advertisement or public service message, and/or an identifier that identifies the on-hold audio content subscriber (e.g., the user or administrator of the telephone system 76, or the organization owning the telephone system 76).

In FIG. 8, a caller 90 places an incoming call to the telephone system 76 via the communication network 74, and the telephone system 76 receives the incoming telephone call from the caller 90. The podcast on hold software 122 causes the telephone system 76 to respond to input from a user of the telephone system 76 indicating that the telephone call needs to be placed on hold by initiating a VoIP call to a server system 72 via the communication network 74 as indicated in FIG. 8. The podcast on hold software 122 also causes the telephone system 76 to connect the telephone call to the VoIP call. In response to the incoming VoIP call, the server system 72 joins the VoIP call to a conference call in progress, thereby joining the telephone call from the caller 90 to the conference call.

Within the server system 72, the audio file 120 is being rendered or played (e.g., by a media player), thereby generating an audio signal that conveys the audio content contained in the audio file 120. The server system 72 provides the audio signal to the conference call connection. As a result, the caller 90 receives the audio signal from the server system 72 conveying the audio content contained in the audio file 120 while on hold and joined in the conference call. Multiple callers placed on hold may be joined in the ongoing conference call. Audio input from each of the callers is preferably muted so that the callers joined in the conference call do not hear caller generated audio.

The server system 72 may include multiple audio files, including the audio file 120, where each of the audio files includes audio content to be delivered to a caller placed on hold. Each of the audio files may correspond to a different subscriber, and each audio file may be generated by the server 72 based on configuration information provided by the corresponding subscriber.

In some embodiments, the server system 72 selects one of the audio files to be rendered or played based on caller or calling number identification information received by the server system 72 when the telephone system 76 places the VoIP call to the server system 72. There are many different ways to convey caller or calling number identification information when a telephone call is placed, including Caller ID, calling line identification (CLID), and automatic number identification (AIN).

When the server system 72 receives the VoIP call from the telephone system 76, the server system 72 may receive caller or calling number identification information identifying a corresponding subscriber (e.g., the user or administrator of the telephone system 76, or the organization owning the telephone system 76). The server system 72 may use the caller or calling number identification information to select the audio file corresponding to the subscriber (e.g., the audio file 120). The server system 72 may render or play the audio file, thereby generating an audio signal that conveys the audio content contained in the audio file.

In other embodiments, the server system 72 associates each of the multiple audio files with a telephone number of the server system 72 (i.e., with a called telephone number). When the telephone system 76 places a VoIP call to the server system 72, the server system 72 renders or plays the audio file (e.g., the audio file 120) corresponding to the called telephone number, thereby generating an audio signal that conveys the audio content contained in the audio file.

Before providing the audio signal to the conference call connection, the server system 72 may first provide an introductory message. The introductory message may be selected based on the caller or calling number identification information, or on the called telephone number. As a result, the caller receives the introductory message and/or the audio content contained in the audio file while on hold and joined in the conference call.

The session initiation protocol (SIP) is the most widely used VoIP call control protocol. While SIP is responsible for determining the peer Internet protocol (IP) address and port number on which to communicate, it does not perform the actual physical transport of the media. Physical transport of the media is usually accomplished using the transmission control protocol (TCP) and IP, or TCP/IP.

When a caller initiates a VoIP call from a “caller side,” SIP issues an INVITE message to an indicated “called side.” The INVITE message includes basic call set-up information, such as the called and caller addresses, proxy information, and voice coder (vocoder) details. The called side responds with a SIP TRYING message to acknowledge the call request. Signaling then proceeds on the called side to set up the call and generate ring (i.e., alert the called party to the incoming call).

When ringing is successful, a RINGING message is returned to the caller side, where the appropriate ringback can be generated to the caller. When the called side goes off hook (i.e., the called party answers the incoming call), a connect is performed on the called side, enabling the media stream. SIP generates an OK message to indicate this state change. In response, the caller side connects the call and acknowledges the connect with an ACK message. A two-way connection is thus established. When either side hangs up, SIP generates a BYE message. In receipt of the BYE message, the opposite side proceeds with a disconnect and acknowledges the call termination with an OK message.

The telephone system 76 may including a switching network having multiple ports: several outside ports and several inside ports. In response to input indicating that the incoming call from the caller 90, received via a corresponding one of the outside ports, needs to be placed on hold, the telephone system 76 may initiate a VoIP call to the server system 72 as indicated in FIG. 8 (e.g., via the SIP protocol). The switching network may form a connection between one of the inside or outside ports and the VoIP call, and may form a connection between the corresponding outside port and the port connected to the VoIP call. In response to the incoming VoIP call, the server system 72 may join the telephone call from the caller 90 to the conference call in progress as described above via a conference call connection. A media player of the server system 72 may be rendering or playing the audio file 120, and providing a resultant audio signal to the conference call connection. In this situation, the audio signal generated by the media player is provided to the caller 90 while the caller 90 is on hold.

In response to input from a user of the telephone system 76 that the incoming call on hold needs to be taken off of hold, the switching network may break the connection between the corresponding outside port and the inside port connected to the VoIP call. The telephone system 76 may send a SIP BYE message to the server system 72 indicating that the VoIP call is ended. The switching network may form a connection between the outside port and one of the inside ports. In this way, the caller 90 is taken off of hold and expectedly connected to a receiving party within the building.

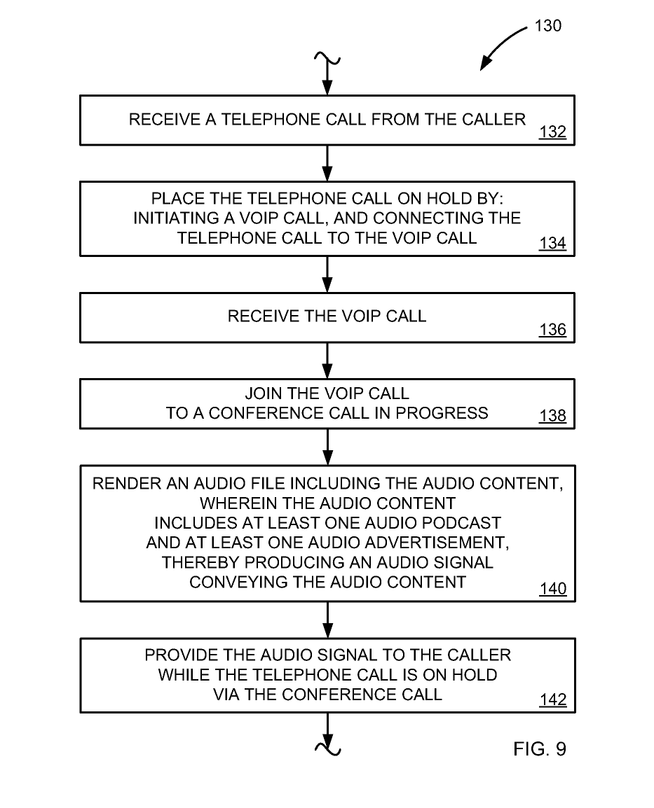

FIG. 9 is a flowchart of one embodiment of a method 130 for delivering audio content to a telephone caller placed on hold. During a step 132 of the method 130, a telephone call is received from the caller (e.g., by the telephone system 76 of FIG. 8). The telephone call is placed on hold during a step 134 by: initiating a VoIP call (e.g., to the server system 72 of FIG. 8), and connecting the telephone call to the VoIP call. The step 134 may be carried out in response to user input indicating that the telephone call needs to be placed on hold. During a step 136, the VoIP call is received (e.g., by the server system 72 of FIG. 8). The VoIP call is joined to a conference call in progress (e.g., by the server system 72 of FIG. 8) during a step 138.

During a step 140, the audio file is rendered or played (e.g., by the server system 72 of FIG. 8). The audio file includes the audio content, where the audio content may include at least one audio podcast and at least one audio advertisement or public service message. One or more of the podcasts included in the audio file may be publicly available via the Internet and specified by an RSS feed. As described above, each audio podcast included in the audio content may be or include recorded verbal communication, or recorded music. Each audio advertisement included in the audio content may be, for example, a recorded verbal communication promoting a specific product or brand name, or a public service message. Within the audio content, the audio podcasts, the audio advertisements, and the public service messages may be arranged in sequence. For example, the audio content may include multiple audio podcasts, multiple audio advertisements, and multiple public service messages, where each of the audio advertisements and public service messages is either before, during, or after one of the audio podcasts. As described above, the audio file is preferably formatted according to the MPEG MP3 file format. Alternately, the audio file may be any one of several suitable standard audio file formats, such as the WAV format or the WMA format.

As a result of the rendering or playing of the audio file during the step 140, an audio signal is produced (e.g., by the server system 72 of FIG. 8) that conveys the audio content. During a step 142, the audio signal is provided to the conference call connection (e.g., by the server system 72 of FIG. 8) such that the caller receives the audio signal while the telephone call is on hold.

For example, in response to input indicating that the incoming call from the caller, received via a corresponding outside port, needs to be placed on hold, a telephone system (e.g., the telephone system 76 of FIG. 8) may initiate a VoIP call to a server system (e.g., to the server system 72 of FIG. 8 via the SIP protocol). A switching network of the telephone system may form a connection between one of several inside or outside ports and the VoIP call, and may form a connection between the corresponding outside port and the port connected to the VoIP call. In response to the incoming VoIP call, the server system may join the telephone call from the caller to the conference call in progress via a conference call connection. A media player of the server system may be rendering or playing the audio file, and providing the resultant audio signal to the conference call connection. In this situation, the audio signal generated by the media player is provided to the caller while the caller is on hold.

In response to input from a user of the telephone system that the incoming call on hold needs to be taken off of hold, the switching network may break the connection between the corresponding outside port and the inside port connected to the VoIP call. The telephone system may, for example, send a SIP BYE message to the server system indicating that the VoIP call is ended. The switching network may form a connection between the outside port and one of the inside ports. In this way, the caller is taken off of hold and expectedly connected to a receiving party within the building.

Numerous variations and modifications will become apparent to those skilled in the art once the above disclosure is fully appreciated. It is intended that the following claims be interpreted to embrace all such variations and modifications.

What is claimed is:

1. An on-hold phonecasting method that comprises:
establishing a two-way telecommunications link between a caller and a call terminus;
temporarily isolating the caller or the call terminus from the link;
providing audio content via the link while said caller or call terminus is isolated to indicate that the link is still in place; and
wherein at least a portion of said audio content is specified by a really simple syndication (RSS) feed.

2. The method of claim 1, wherein said audio content includes a podcast that is publicly available via the Internet.

3. The method of claim 1, further comprising generating the audio content by concatenating an audio advertisement or public service message with said portion.

4. The method of claim 3, wherein said generating is performed based on parameters of configuration information, wherein the parameters include a URL for the RSS feed.

5. The method of claim 4, wherein the parameters further include an identifier for said audio advertisement or public service message.

6. The method of claim 4, wherein the parameters further include an identifier of an on-hold audio content subscriber.

7. The method of claim 1, further comprising:
periodically checking the RSS feed for updates to the audio content; and
downloading updated audio content.

8. The method of claim 7, further comprising reformatting the updated audio content to a companded format suitable for telephone or voice over Internet protocol (VoIP) communications links.

9. The method of claim 1, wherein said providing includes conferencing the link together with a voice over Internet protocol (VoIP) call to a server system.

10. A telephone system that comprises:
a memory that stores PBX software;
at least one processor coupled to the memory to execute the PBX software, wherein the PBX software configures the processor to:
establish a two-way telecommunications link between a caller and a call terminus;
isolate the caller or the call terminus from the link; and
provide audio content via the link until two-way communication is re-established;
wherein at least a portion of said audio content is from a syndicated program.

11. The system of claim 10, wherein the syndicated program is a podcast.

12. The system of claim 10, wherein as part of providing said audio content, the PBX software configures the processor to connect the link to a server system via a VoIP call.

13. The system of claim 12, wherein the telephone system generates said audio content by combining an audio message with the syndicated program.

14. The system of claim 13, wherein the message is an advertisement or public service message.

15. The system of claim 13, wherein the telephone system selects the audio message based on caller or calling number identification information.

16. The system of claim 10, wherein as part of providing said audio content, the PBX software configures the processor to periodically check for updates to the syndicated program and to download updated audio content when an update is detected.

17. The system of claim 16, wherein the PBX software further configures the processor to convert the updated audio content into a constant bit rate format.

18. A telephone system, comprising:
means for receiving media file fetcher software comprising computer instructions for downloading an audio file, wherein the audio file is generated using configuration information, and wherein the audio file comprises at least one audio podcast and at least one audio advertisement;
means for executing the media file fetcher software, thereby receiving the audio file;
means for playing the audio file, thereby producing an audio signal conveying the audio content;
means for receiving a telephone call from the caller;
means for placing the telephone call on hold; and
means for providing the audio signal to the caller while the telephone call is on hold.

19. The telephone system as recited in claim 18, wherein the at least one audio advertisement is positioned before, during, or after the at least one audio podcast.

20. The telephone system as recited in claim 18, wherein the audio file comprises a plurality of audio podcasts and a plurality of audio advertisements arranged in sequence, and wherein each of the audio advertisements is either before, during, or after one of the audio podcasts.

21. The telephone system as recited in claim 18, wherein the configuration information comprises a list of the at least one audio podcast to be included in the audio file.

22. The telephone system as recited in claim 21, wherein the configuration information further comprises a list of the at least one audio advertisement to be included in the audio file.

23. The telephone system as recited in claim 18, wherein the audio file is formatted for playback over a telephone connection.

24. A telephone system, comprising:
means for receiving a telephone call from a caller;
means for placing the telephone call on hold by:
initiating a voice over Internet protocol (VoIP) call to a server system; and
connecting the telephone call to the VoIP call.

25. The telephone system of claim 24, wherein the server system answers the VoIP call with audio content that includes a podcast associated with a called telephone number.

26. The telephone system of claim 25, wherein the audio content further includes an introductory message determined based on a source of the VoIP call.
